(19) United States
(12) Patent Application Publication
(10) Pub. No.: US 2026/0364692 A1
(43) Pub. Date: Nov. 19, 2026

(54) Reaming Tool

(71) Applicant: Weiqi MO, Dongguan (CN)

(72) Inventor: Weiqi MO, Dongguan (CN)

(21) Appl. No.: 19/755,435

(22) Filed: Jul. 27, 2026

Related U.S. Application Data
(63) Continuation-in-part of application No. 19/645,651, filed on Apr. 13, 2026, now Pat. No. 12,746,611.

(51) Int. Cl. B23D 77/02; B23D 75/00; B23D 77/14

(52) U.S. Cl. CPC B23D 77/02; B23D 75/005; B23D 77/14

(57) ABSTRACT

A reaming tool, including a gripping body, a first reaming head, and a second reaming head. The gripping body includes a first working end, a second working end, and a receiving space formed inside the gripping body. The first reaming head is detachably mounted to the first working end, and the second reaming head is detachably mounted to the second working end. The first reaming head and the second reaming head are configured to be simultaneously receivable within the receiving space. Each reaming head is in a stepped shaft shape with two working heads of different sizes, covering 4AN, 6AN, 8AN, and 10AN hose specifications. The two reaming heads are interchangeably mountable to either working end and secured by end caps.

### CROSS-REFERENCE TO RELATED APPLICATIONS

This application is a continuation in part application of application Ser. No. 19/645,651, filed Apr. 13, 2026. The contents of this application are incorporated herein by reference in their entirety.

### TECHNICAL FIELD

The present disclosure relates to the technical field of hand tools, in particular to a reaming tool for PTFE hoses.

### BACKGROUND

With the rapid development of the automotive industry, hydraulic systems, and fluid transmission fields, PTFE hoses (Teflon tubes), owing to their excellent high-temperature resistance and corrosion resistance, are widely used in various pipeline connection systems. However, before assembling PTFE hoses with fittings, it is necessary to first strip the outer stainless steel braided layer and trim the tube opening, a process that imposes high requirements on reaming tools.

Currently, PTFE hose reaming tools available on the market have a main body structure that can only accommodate two sizes of reaming heads simultaneously, such as a set of 4AN and 6AN, or a set of 8AN and 10AN. Since the commonly used dimensions of PTFE hoses cover four specifications—4AN, 6AN, 8AN, and 10AN—users often need to purchase or carry two different reaming tools at the same time to cover all operational requirements. This not only increases the cost of use but also causes inconvenience in tool storage and difficulties in portability.

To this end, the present disclosure provides a reaming tool aimed at solving the problems of poor single-tool compatibility and inconvenience in carrying in the prior art.

### SUMMARY

In order to overcome the deficiencies of the prior art, the present disclosure provides a reaming tool that has a compact structure and is provided with a first reaming head detachably mounted on a first working end and a second reaming head detachably mounted on a second working end. The two reaming heads can be simultaneously received within the receiving space of the gripping body, enabling a single tool to carry four working heads of different sizes. This effectively reduces the cost of use, solves the problems of inconvenient carrying and easy loss of working heads in traditional reaming tools, and further improves operational flexibility and ease of use by allowing reaming heads to be mounted on both ends.

To realize the above objective, the present disclosure provides a reaming tool, including: a gripping body including a first working end, a second working end, and a receiving space formed inside the gripping body; a first reaming head detachably mounted to the first working end; a second reaming head detachably mounted to the second working end; wherein the first reaming head and the second reaming head are configured to be simultaneously receivable within the receiving space of the gripping body.

In one embodiment, the receiving space includes a first mounting channel located at the first working end and a second mounting channel located at the second working end.

In one embodiment, the first reaming head is in a stepped shaft shape and includes a first abutment convex ring having the largest outer diameter, and two first transition shaft segments respectively disposed on two sides of the first abutment convex ring, wherein the two first transition shaft segments respectively extend outwardly to form a first working head and a second working head of different sizes.

In one embodiment, the second reaming head is overall in a stepped shaft shape and includes a second abutment convex ring having the largest outer diameter, and two second transition shaft segments respectively disposed on two sides of the second abutment convex ring, wherein the two second transition shaft segments respectively extend outwardly to form a third working head and a fourth working head of different sizes.

In one embodiment, an outer diameter of the first abutment convex ring is equal to an outer diameter of the second abutment convex ring.

In one embodiment, an outer diameter of each of the two first transition shaft segments is equal to an outer diameter of each of the two second transition shaft segments.

In one embodiment, the first working end includes a first abutment end surface, the second working end includes a second abutment end surface, and both the first abutment convex ring and the second abutment convex ring are each configured to abut against the first abutment end surface or the second abutment end surface.

In one embodiment, the first working head, the second working head, the third working head, and the fourth working head are respectively configured to match four different sizes of hoses.

In one embodiment, the four different sizes include 4AN, 6AN, 8AN, and 10AN.

In one embodiment, further including a first end cap, wherein the first working end of the gripping body is provided with a first external thread, and the first end cap is provided with a first internal thread that mates with the first external thread, thereby securing the first abutment convex ring or the second abutment convex ring against the first abutment end surface when the first reaming head or the second reaming head is mounted to the first working end.

In one embodiment, the first end cap includes a first end cap through-hole, wherein a size of the first end cap through-hole matches the outer diameter of each of the two first transition shaft segments and the two second transition shaft segments; wherein, when the first end cap is threadedly connected to the first working end, one of the working heads of the first reaming head or the second reaming head mounted to the first working end extends out from the first end cap through-hole for mating with a hose of a corresponding size, while the other of the working heads of the first reaming head or the second reaming head is received within the first mounting channel.

In one embodiment, further including a second end cap, wherein the second working end of the gripping body is provided with a second external thread, and the second end cap is provided with a second internal thread that mates with the second external thread, thereby securing the first abutment convex ring or the second abutment convex ring against the second abutment end surface when the first reaming head or the second reaming head is mounted to the second working end.

In one embodiment, the second end cap includes a second end cap through-hole, wherein a size of the second end cap through-hole matches the outer diameter of each of the two first transition shaft segments and the two second transition shaft segments; wherein, when the second end cap is threadedly connected to the second working end, one of the working heads of the first reaming head or the second reaming head mounted to the second working end extends out from the second end cap through-hole for mating with a hose of a corresponding size, while the other of the working heads of the first reaming head or the second reaming head is received within the second mounting channel.

In one embodiment, the first reaming head and the second reaming head are interchangeably mountable to the first working end or the second working end.

In one embodiment, a radial cross-section of an outer contour of the gripping body is configured as a regular polygon.

In one embodiment, an isolation layer is further provided between the first mounting channel and the second mounting channel, and the isolation layer is used to increase the strength of the gripping body.

In one embodiment, radial cross-sections of the first mounting channel and the second mounting channel are configured to be circular.

In one embodiment, inner diameters of the first mounting channel and the second mounting channel are equal.

In one embodiment, the gripping body is made of a rigid material.

In one embodiment, both the first reaming head and the second reaming head are made of a rigid material.

The technical solution adopted by the present disclosure to solve its technical problems is as follows: The beneficial effects of the present disclosure are: Through the arrangement of the above structure, during use, the user can selectively mount either the first reaming head or the second reaming head on the first working end, while the other reaming head is mounted and stored on the second working end. The two reaming heads are simultaneously received within the receiving space of the gripping body, realizing a portable storage logic of “one stored, one in use.” When it is necessary to switch the hose size, the user only needs to detach the currently mounted reaming head from the working end and store it on the second working end, while simultaneously removing the other reaming head from the second working end and mounting it onto the first working end. This “dual-head interchangeable, ready-to-use” switching mode allows a single tool to carry four working heads of different sizes, covering the four commonly used hose specifications of 4AN, 6AN, 8AN, and 10AN. Compared with the traditional method that requires carrying multiple tools, the cost of use is significantly reduced, and the convenience of carrying and storage is effectively improved. Taking the receiving space as the storage benchmark, the two reaming heads can be simultaneously received inside the gripping body, so that the user does not need to carry additional spare working heads, effectively avoiding the risk of losing the working heads. Both the first working end and the second working end are provided with end cap locking structures to ensure that the reaming head mounted on the working end remains stable during the reaming operation, thereby guaranteeing the precision and consistency of the reaming operation.

### BRIEF DESCRIPTION OF DRAWINGS

In order to more clearly illustrate the technical solutions in the embodiments of the present disclosure, the drawings required for use in the description of the embodiments will be briefly introduced below. The drawings in the following description are merely some embodiments of the present disclosure. For those of ordinary skill in the art, other drawings can be obtained based on these drawings without creative effort. In addition, the drawings are not drawn to a 1:1 scale, and the relative dimensions of various components in the drawings are merely illustratively drawn and are not necessarily drawn according to actual proportions.

The present disclosure will be further described below in conjunction with the drawings and embodiments.

FIG. 1 is a schematic structural diagram of a reaming tool of the present disclosure from a first perspective.

FIG. 2 is a schematic structural diagram of the reaming tool of the present disclosure from a second perspective.

FIG. 3 is a cross-sectional view of the reaming tool of the present disclosure.

FIG. 4 is an exploded view of the reaming tool of the present disclosure from the first perspective.

FIG. 5 is an exploded view of the reaming tool of the present disclosure from the second perspective.

FIG. 6 is an enlarged view of a portion A circled in FIG. 3.

### Description of the Reference Numerals

100, gripping body; 200, first reaming head; 300, second reaming head; 400, first end cap; 500, second end cap; 110, first working end; 111, first abutment end surface; 112, first external thread; 120, second working end; 121, second abutment end surface; 122, second external thread; 130, receiving space; 131, first mounting channel; 132, second mounting channel; 140, isolation layer; 210, first abutment convex ring; 220, first transition shaft segment; 230, first working head; 240, second working head; 310, second abutment convex ring; 320, second transition shaft segment; 330, third working head; 340, fourth working head; 410, first internal thread; 420, first end cap through-hole; 510, second internal thread; 520, second end cap through-hole.

### DETAILED DESCRIPTION OF THE EMBODIMENTS

In order to make the above objects, features, and advantages of the present disclosure more obvious and understandable, the specific embodiments of the present disclosure will be described in detail below in conjunction with the accompanying drawings. In the following description, numerous specific details are set forth in order to provide a full understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

In the description of the present disclosure, it should be understood that if the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like appear, these terms indicate orientations or positional relationships based on the orientations or positional relationships shown in the drawings, and are merely for the convenience of describing the present disclosure and simplifying the description, rather than indicating or implying that the referred device or element must have a specific orientation, be constructed and operated in a specific orientation, and therefore cannot be understood as a limitation on the present disclosure.

In addition, if the terms “first” and “second” appear, these terms are used for descriptive purposes only and cannot be understood as indicating or implying relative importance or implicitly indicating the number of the indicated technical features. Thus, a feature defined as “first” or “second” may explicitly or implicitly include at least one of that feature. In the description of the present disclosure, if the term “plurality” appears, the meaning of “plurality” is at least two, for example, two, three, etc., unless otherwise expressly and specifically limited.

In the present disclosure, unless otherwise expressly specified and limited, if the terms “mount,” “connect,” “link,” “fix,” and the like appear, these terms should be understood in a broad sense. For example, it may be a fixed connection, a detachable connection, or an integral connection; it may be a mechanical connection or an electrical connection; it may be a direct connection or an indirect connection through an intermediate medium, or it may be the internal communication of two elements or the interaction relationship between two elements, unless otherwise expressly limited. For those of ordinary skill in the art, the specific meanings of the above terms in the present disclosure can be understood according to specific circumstances.

In the present disclosure, unless otherwise expressly specified and limited, if a description such as a first feature being “on” or “under” a second feature appears, its meaning may be that the first and second features are in direct contact, or that the first and second features are in indirect contact through an intermediate medium. Moreover, the first feature being “above,” “over,” and “on” the second feature may mean that the first feature is directly above or obliquely above the second feature, or merely indicates that the first feature is horizontally higher than the second feature. The first feature being “below,” “under,” and “beneath” the second feature may mean that the first feature is directly below or obliquely below the second feature, or merely indicates that the first feature is horizontally lower than the second feature.

It should be noted that if an element is referred to as being “fixed to” or “disposed on” another element, it may be directly on the other element or there may be an intervening element. If an element is considered to be “connected to” another element, it may be directly connected to the other element or there may be intervening elements present at the same time. If present, the terms “vertical,” “horizontal,” “upper,” “lower,” “left,” “right,” and similar expressions used in the present disclosure are for illustrative purposes only and do not represent the only embodiments.

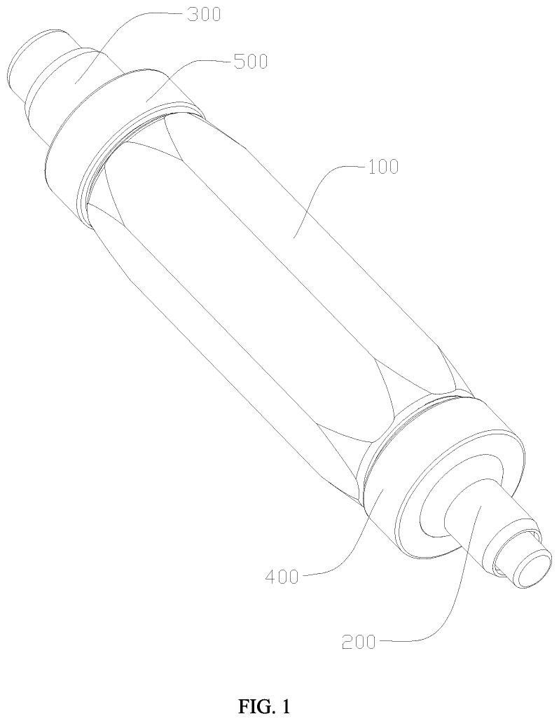

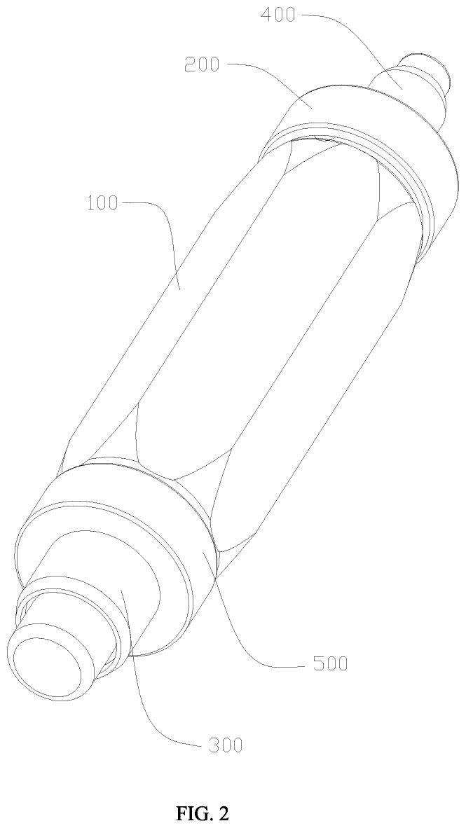

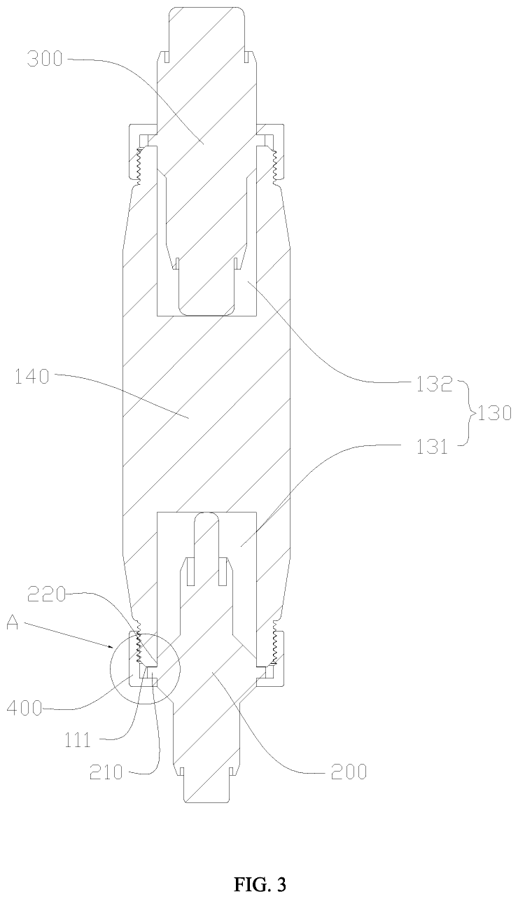

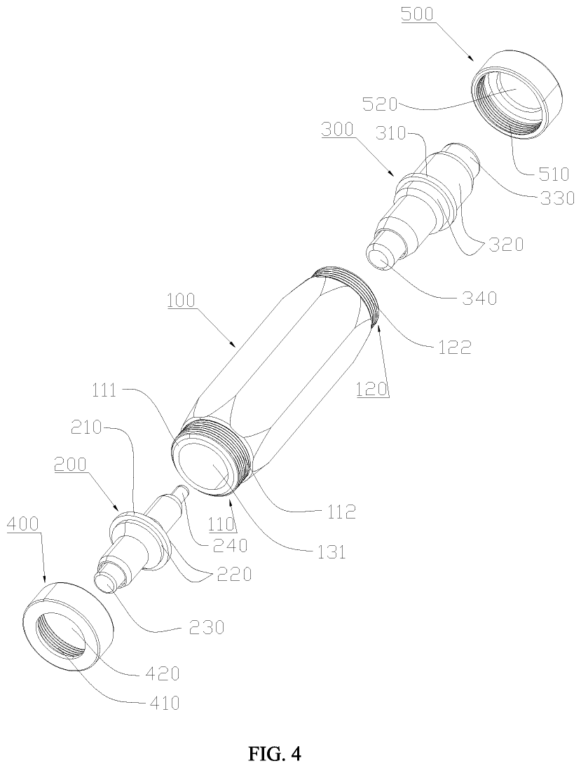

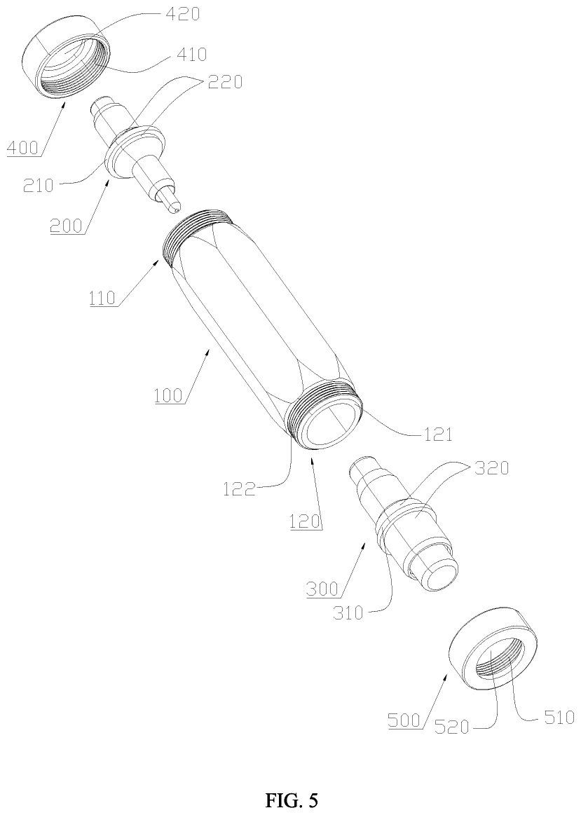

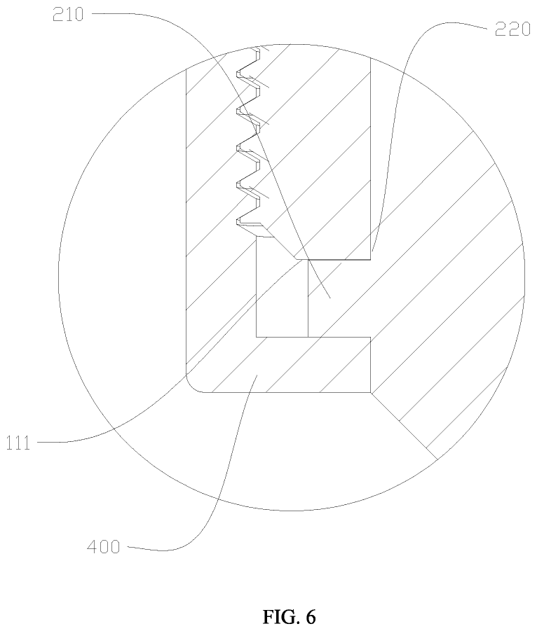

A reaming tool, as shown in FIGS. 1 to 6, includes: a gripping body 100, a first reaming head 200, and a second reaming head 300.

The gripping body 100 includes a first working end 110 and a second working end 120, and a receiving space 130 formed inside the gripping body 100.

The first reaming head 200 is detachably mounted at the first working end 110.

The second reaming head 300 is detachably mounted at the second working end 120.

The first reaming head 200 and the second reaming head 300 are configured to be simultaneously receivable within the receiving space 130 of the gripping body 100.

The receiving space 130 includes a first mounting channel 131 located at the first working end 110 and a second mounting channel 132 located at the second working end 120.

By the arrangement of the above structure, during use the user may mount the first reaming head at the first working end and the second reaming head at the second working end. Both ends are provided with detachable mounting structures, whereby the user may, according to actual operating requirements, select either end as the operating end for reaming, with the other end simultaneously receiving the other reaming head, thereby realizing a collaborative mode of “dual ends for working, one used and one stored.” The two reaming heads are simultaneously received within the receiving space inside the gripping body and are respectively located in the first mounting channel and the second mounting channel, thereby fully utilizing the internal space of the tool body, avoiding the inconvenience of additionally carrying spare reaming heads, and effectively reducing the risk of loss of the reaming heads. This interchangeable dual working-end, dual reaming-head design enables a single tool to cover reaming requirements of different specifications, significantly lowering the cost of use, enhancing the convenience of carrying and storage, and allowing both ends to be used as working ends, thereby further enhancing operational flexibility and effectively solving the problems in the prior art of single-function reaming tools, inconvenient carrying, and restricted operating directions.

In the present embodiment, the first reaming head 200 is overall in the form of a stepped shaft, including a first abutment convex ring 210 of maximum outer diameter, and two first transition shaft segments 220 respectively disposed on two sides of the first abutment convex ring 210. The two first transition shaft segments 220 respectively protrude outwardly to form first working head 230 and second working head 240 of different sizes. The second reaming head 300 is overall in the form of a stepped shaft, including a second abutment convex ring 310 of maximum outer diameter, and two second transition shaft segments 320 respectively disposed on two sides of the second abutment convex ring 310. The two second transition shaft segments 320 respectively protrude outwardly to form a third working heads 330 and fourth working heads 340 of different sizes.

By the arrangement of the above structure, the first reaming head 200 and the second reaming head 300 adopt a dual-head stepped-shaft structure design, each reaming head integrates two working heads of different sizes, thereby enabling a single reaming head to cover the functions of two different hose sizes. When either reaming head is mounted at the first working end 110 or the second working end 120, each of the transition shaft segments cooperates with the corresponding mounting channel to ensure coaxiality of the working head with the gripping body 100. Its abutment convex ring abuts against the abutment end surface of the corresponding working end, providing axial positioning and thereby ensuring stability during reaming operations. When each of the reaming heads is received at the other working end, stable storage is likewise realized through cooperation of the respective transition shaft segments with the mounting channel and abutment positioning of the abutment convex ring.

In the present embodiment, the outer diameter of the first abutment convex ring 210 is equal to the outer diameter of the second abutment convex ring 310, and the outer diameter of each of the two first transition shaft segments 220 is equal to the outer diameter of each of the two second transition shaft segments 320. By the arrangement of the above structure, radial dimensions of the two reaming heads are unified. The equal outer diameters of the abutment convex rings enable the first reaming head 200 and the second reaming head 300 to be universally adapted to the abutment end surface of the same working end, regardless of whether mounted at the first working end 110 or the second working end 120, thereby obtaining consistent axial positioning effect. The equal outer diameters of the transition shaft segments enable the two reaming heads to be universally adapted to the first mounting channel 131 and the second mounting channel 132, ensuring that when either reaming head is mounted at either working end, each of the transition shaft segments cooperates with the corresponding mounting channel in an adapted manner, thereby ensuring coaxiality of the working head with the gripping body 100. This dimensionally uniform design eliminates installation limitations caused by radial dimensional differences, enabling the first reaming head 200 and the second reaming head 300 to achieve complete interchangeability between the first working end 110 and the second working end 120, thereby further enhancing the operational flexibility and convenience of use of the tool.

In the present embodiment, the first working end 110 includes a first abutment end surface 111, the second working end 120 includes a second abutment end surface 121, and the first abutment convex ring 210 and the second abutment convex ring 310 are both configured to be abuttable against the first abutment end surface 111 and the second abutment end surface 121. By the arrangement of the above structure, each working end is provided with an abutment end surface, and the abutment convex rings of the two reaming heads are each adapted to abut against either abutment end surface, thereby realizing a universalized cooperation of “positioning available at both ends and both parts interchangeable.” Whether the first reaming head 200 is mounted at the first working end 110 or the second working end 120, its first abutment convex ring 210 can reliably abut against the abutment end surface of the corresponding working end, providing axial limit. Similarly, the second reaming head 300 can also be universally adapted to either working end. This dual end surface/double convex ring cooperating structure, combined with the prior dimensionally uniform design of equal outer diameters of the abutment convex rings and transition shaft segments, structurally ensures complete interchangeability of the first reaming head 200 and the second reaming head 300 between the first working end 110 and the second working end 120, whereby the user need not distinguish correspondence between the reaming head and the working end, and any reaming head mounted at any working end obtains consistent axial positioning effect, thereby further enhancing operational convenience and effectively avoiding operational errors caused by installation direction or matching mistakes.

In the present embodiment, the first working head 230, the second working head 240, the third working head 330, and the fourth working head 340 are respectively configured to match four different sizes of hoses; the four different sizes include 4AN, 6AN, 8AN, and 10AN. By the arrangement of the above structure, the four working heads respectively match the four common sizes of PTFE hoses, 4AN, 6AN, 8AN, and 10AN, thereby covering the vast majority of application scenarios in the automotive, hydraulic, and fluid transmission fields. Through the combination configuration of the two reaming heads and four working heads, the user need only carry a single tool body to satisfy the reaming requirement for all commonly used sizes of hoses, without purchasing or carrying multiple tools according to different sizes. This one-tool-all-cover design lowers the cost of use, solves the problem of incomplete size coverage in traditional tools and the need to use multiple tools in cooperation, and thereby further enhances the user experience.

In the present embodiment, the reaming tool further includes a first end cap 400, the first working end 110 of the gripping body 100 being provided with a first external thread 112, the first end cap 400 being provided with a first internal thread 410 cooperating with the first external thread 112. During use, when the first reaming head 200 or the second reaming head 300 is mounted at the first working end 110, the first end cap 400 secures the first abutment convex ring 210 or the second abutment convex ring 310 against the first abutment end surface 111. The first end cap 400 includes a first end cap through-hole 420, the size of the first end cap through-hole 420 being matched to the outer diameters of each of the two first transition shaft segments 220 and each of the two second transition shaft segments 320. When the first end cap 400 is threadedly connected to the first working end 110, one working head of the first reaming head 200 or the second reaming head 300 mounted at the first working end 110 protrudes from the first end cap through-hole 420 for cooperating with the corresponding size of hose, while the other working head of the first reaming head 200 or the second reaming head 300 is received within the first mounting channel 131.

By the arrangement of the above structure, the first end cap 400 threadedly snaps the abutment convex ring of the reaming head mounted at the first working end 110 to the first abutment end surface 111, thereby achieving axial locking of the reaming head at the working end, effectively preventing axial slip or accidental detachment of the reaming head during the reaming operation, and guaranteeing stability and safety of the reaming operation. At the same time, the size of the first end cap through-hole 420 is matched to the outer diameters of the two reaming heads' transition shaft segments, enabling the end cap during locking to form radial cooperation with the transition shaft segments, thereby further ensuring coaxiality of the working head with the gripping body 100 and improving reaming precision. After the end cap is locked, one working head of the reaming head mounted at the first working end 110 protrudes from the end cap through-hole 420 for the reaming operation, while the other working head of the reaming head is received within the first mounting channel 131, thereby realizing rapid switching of the working head—only by removing the reaming head, reversing its direction, and re-mounting it to use the other size working head—while the idle working head is effectively protected during the operating process, avoiding impact damage. The first end cap 400, through a single threaded tightening operation, simultaneously realizes multiple functions of axial locking, radial positioning, working-head protrusion, and idle working-head storage, with a simple structure and convenient operation, thereby further enhancing the user experience of the reaming tool.

In this embodiment, the reaming tool further includes a second end cap 500. The second working end 120 of the gripping body 100 is provided with a second external thread 122, and the second end cap 500 is provided with a second internal thread 510 that cooperates with the second external thread 122. During use, when the first reaming head 200 or the second reaming head 300 is mounted on the second working end 120, the second end cap 500 clamps the first abutment convex ring 210 or the second abutment convex ring 310 against the second abutment end surface 121. The second end cap 500 includes a second end cap through-hole 520, the size of the second end cap through-hole 520 is matched with the outer diameter of each of the two first transition shaft segments 220 and the outer diameter of each of the two second transition shaft segments 320. When the second end cap 500 is threadedly connected to the second working end 120, one working head of the first reaming head 200 or the second reaming head 300 mounted on the second working end 120 protrudes from the second end cap through-hole 520 for cooperation with a hose of corresponding size, and the other working head of the first reaming head 200 or the second reaming head 300 is received in the second mounting channel 132.

Through the provision of the above-described structure, the second end cap 500 threadedly clamps the abutment convex ring of the reaming head mounted on the second working end 120 against the second abutment end surface 121, thereby achieving axial locking of the reaming head at the second working end, effectively preventing axial slipping or accidental detachment of the reaming head during the reaming operation, and ensuring the stability and safety of the reaming operation. Meanwhile, the size of the second end cap through-hole 520 is matched with the outer diameters of each of the transition shaft segments of the two reaming heads, such that the end cap can form a radial fit with each of the transition shaft segments during the locking process, further ensuring that the working head maintains good coaxiality with the gripping body 100, thereby improving the reaming accuracy.

After the end cap is locked, one working head of the reaming head mounted on the second working end 120 protrudes from the end cap through-hole 520 for performing the reaming operation, while the other working head of the reaming head is received in the second mounting channel 132, thereby achieving rapid switching of the working heads—simply by removing the reaming head, reversing its direction, and re-installing it to use a working head of another size—while effectively protecting the idle working head from impacts or damage during operation. The second end cap 500 and the first end cap 400 are respectively disposed at both ends of the gripping body 100, having a symmetrical and functionally consistent structure; users can obtain the same locking effect and operational experience regardless of which end of the tool they are accustomed to using for the reaming operation, thereby further enhancing the applicability and convenience of use of the tool.

In this embodiment, the first reaming head 200 and the second reaming head 300 may be interchangeably mounted on the first working end 110 or the second working end 120; the radial cross-section of the outer contour of the gripping body 100 is configured as a regular polygon.

With the above-described structure, the first reaming head 200 and the second reaming head 300 may be fully interchangeable between the first working end 110 and the second working end 120. In combination with the dimensionally uniform design in which the outer diameters of the abutment convex rings, the outer diameters of the transition shaft segments, the abutment end surfaces at both ends, and the end cap structures are all identical, axial positioning, radial fit, and locking may be achieved when any reaming head is mounted on any working end, such that users need not distinguish the correspondence between the reaming heads and the working ends but may directly install them according to the requirements of the operation, thereby reducing the operational threshold and risk of incorrect mounting and further improving the operational flexibility and interchangeability of the tool.

Meanwhile, the radial cross-section of the outer contour of the gripping body 100 being configured as a regular polygon provides an obvious anti-rolling advantage compared to a circular cross-section. When the tool is placed on an inclined or vibrating operating surface, it is less likely to roll away, thereby improving the safety of tool storage and the convenience of use. In addition, the outwardly projecting edges of the regular polygon provide a more favorable shape for user gripping and application of force, enabling effective torque transmission during the reaming operation without slippage, thereby further improving the stability and comfort of the reaming operation.

In this embodiment, an isolation layer 140 is further provided between the first mounting channel 131 and the second mounting channel 132. The isolation layer 140 is used to increase the strength of the gripping body 100.

By providing the above-described structure, the first mounting channel 131 and the second mounting channel 132 are separated by the isolation layer 140, such that the two mounting channels do not directly penetrate through each other. The provision of the isolation layer 140, on the one hand, avoids structural weakening of the gripping body 100 due to the formation of a through-cavity caused by channels being opened at both ends, thereby effectively improving the bending and compressive resistance of the gripping body 100 during the forces applied in the reaming operation. On the other hand, the isolation layer 140 provides independent axial limiting references for the working ends at both ends. When the reaming head is mounted on either working end and locked by the end cap, the axial force borne by the abutment convex ring is transmitted to the gripping body 100 through the abutment end surface, and the isolation layer 140 can effectively bear and disperse this force, thereby ensuring that the gripping body 100 does not easily deform or be damaged during long-term use, thereby prolonging the service life of the tool and further improving the reliability and durability of the reaming tool.

In this embodiment, the radial cross-sections of the first mounting channel 131 and the second mounting channel 132 are configured as circles, and the inner diameters of the first mounting channel 131 and the second mounting channel 132 are equal.

Through the provision of the above-described structure, the radial cross-sections of the first mounting channel 131 and the second mounting channel 132 are both circular, which is matched with the circular cross-section of the transition shaft segments of the two reaming heads, such that the transition shaft segments can form a uniform radial fit in the mounting channels, which is advantageous for smooth insertion and withdrawal of the reaming head during installation and simultaneously ensures that the working heads maintain good coaxiality with the gripping body 100.

The equal inner diameters of the two mounting channels, in conjunction with the aforementioned design in which the outer diameters of the transition shaft segments of the two reaming heads are equal, enable the transition shaft segments of the first reaming head 200 and the second reaming head 300 to be universally applicable to either mounting channel; regardless of whether the reaming head is mounted on the first working end 110 or the second working end 120, consistent fitting precision and guiding effects are obtained. The uniform dimensions of the mounting channels at both ends not only simplify the machining process and reduce manufacturing costs but also, from a structural perspective, further guarantee the interchangeability of the two reaming heads between the first working end 110 and the second working end 120, such that users may directly insert them without distinguishing direction when installing or switching the reaming heads, thereby improving the convenience and efficiency of operation.

In this embodiment, the gripping body 100 is made of a rigid material, and the first reaming head 200 and the second reaming head 300 are each made of a rigid material.

With the above-described structure, both the gripping body 100 and the two reaming heads are made of rigid materials, such that the overall reaming tool possesses high structural strength and hardness. On the one hand, in the reaming operation, the rigid material can effectively transmit the operating force, ensuring that the working heads do not easily bend or deform during insertion into the hose, thereby guaranteeing that the reaming force is accurately applied to the hose port and improving the reaming accuracy and efficiency. On the other hand, the working heads of the reaming heads are made of rigid material, which is less prone to wear or deformation during contact and compression with the inner wall of the PTFE hose, and can still maintain dimensional accuracy after long-term use, thereby prolonging the service life of the reaming heads and reducing the frequency and cost of user replacement of components. In addition, the gripping body 100 possesses sufficient rigidity to withstand the axial pressure and torsional moment generated during the reaming operation, and in combination with the strength-enhancing effect of the aforementioned isolation layer 140, further improves the overall damage resistance and reliability of the tool.

The above description provides one or more embodiments in conjunction with specific content and does not imply that the specific embodiments of the disclosure are limited to these descriptions. Any method, structure, or the like that is approximate, similar, or that involves several technical inferences or substitutions based on the concept of the disclosure shall be deemed to fall within the scope of protection of the disclosure.

What is claimed is:

1. A reaming tool, comprising:
a gripping body including a first working end, a second working end, and a receiving space formed inside the gripping body;
a first reaming head detachably mounted to the first working end;
a second reaming head detachably mounted to the second working end;
wherein the first reaming head and the second reaming head are configured to be simultaneously receivable within the receiving space of the gripping body.

2. The reaming tool of claim 1, wherein the receiving space comprises a first mounting channel located at the first working end and a second mounting channel located at the second working end.

3. The reaming tool of claim 2, wherein the first reaming head is in a stepped shaft shape and comprises a first abutment convex ring having the largest outer diameter, and two first transition shaft segments respectively disposed on two sides of the first abutment convex ring, wherein the two first transition shaft segments respectively extend outwardly to form a first working head and a second working head of different sizes.

4. The reaming tool of claim 3, wherein the second reaming head is overall in a stepped shaft shape and comprises a second abutment convex ring having the largest outer diameter, and two second transition shaft segments respectively disposed on two sides of the second abutment convex ring, wherein the two second transition shaft segments respectively extend outwardly to form a third working head and a fourth working head of different sizes.

5. The reaming tool of claim 4, wherein an outer diameter of the first abutment convex ring is equal to an outer diameter of the second abutment convex ring.

6. The reaming tool of claim 4, wherein an outer diameter of each of the two first transition shaft segments is equal to an outer diameter of each of the two second transition shaft segments.

7. The reaming tool of claim 5, wherein the first working end comprises a first abutment end surface, the second working end comprises a second abutment end surface, and both the first abutment convex ring and the second abutment convex ring are each configured to abut against the first abutment end surface or the second abutment end surface.

8. The reaming tool of claim 4, wherein the first working head, the second working head, the third working head, and the fourth working head are respectively configured to match four different sizes of hoses.

9. The reaming tool of claim 8, wherein the four different sizes include 4AN, 6AN, 8AN, and 10AN.

10. The reaming tool of claim 7, further comprising a first end cap, wherein the first working end of the gripping body is provided with a first external thread, and the first end cap is provided with a first internal thread that mates with the first external thread, thereby securing the first abutment convex ring or the second abutment convex ring against the first abutment end surface when the first reaming head or the second reaming head is mounted to the first working end.

11. The reaming tool of claim 10, wherein the first end cap comprises a first end cap through-hole, wherein a size of the first end cap through-hole matches the outer diameter of each of the two first transition shaft segments and the two second transition shaft segments;
wherein, when the first end cap is threadedly connected to the first working end, one of the working heads of the first reaming head or the second reaming head mounted to the first working end extends out from the first end cap through-hole for mating with a hose of a corresponding size, while the other of the working heads of the first reaming head or the second reaming head is received within the first mounting channel.

12. The reaming tool of claim 7, further comprising a second end cap, wherein the second working end of the gripping body is provided with a second external thread, and the second end cap is provided with a second internal thread that mates with the second external thread, thereby securing the first abutment convex ring or the second abutment convex ring against the second abutment end surface when the first reaming head or the second reaming head is mounted to the second working end.

13. The reaming tool of claim 12, wherein the second end cap comprises a second end cap through-hole, wherein a size of the second end cap through-hole matches the outer diameter of each of the two first transition shaft segments and the two second transition shaft segments;
wherein, when the second end cap is threadedly connected to the second working end, one of the working heads of the first reaming head or the second reaming head mounted to the second working end extends out from the second end cap through-hole for mating with a hose of a corresponding size, while the other of the working heads of the first reaming head or the second reaming head is received within the second mounting channel.

14. The reaming tool of claim 1, wherein the first reaming head and the second reaming head are interchangeably mountable to the first working end or the second working end.

15. The reaming tool of claim 1, wherein a radial cross-section of an outer contour of the gripping body is configured as a regular polygon.

16. The reaming tool of claim 2, wherein an isolation layer is further provided between the first mounting channel and the second mounting channel, and the isolation layer is used to increase the strength of the gripping body.

17. The reaming tool of claim 2, wherein radial cross-sections of the first mounting channel and the second mounting channel are configured to be circular.

18. The reaming tool of claim 17, wherein inner diameters of the first mounting channel and the second mounting channel are equal.

19. The reaming tool of claim 1, wherein the gripping body is made of a rigid material.

20. The reaming tool of claim 1, wherein both the first reaming head and the second reaming head are made of a rigid material.
